(19) United States
(12) Patent Application Publication
(10) Pub. No.: US 2018/0226776 A1
(43) Pub. Date: Aug. 9, 2018

(54) Cable Stripping Tool

(71) Applicant: TAVISMANOR LIMITED, Colchester (GB)

(72) Inventor: Barry Peter LIVERSIDGE, Colchester Essex (GB)

(21) Appl. No.: 15/749,856

(22) PCT Filed: Jul. 25, 2016
(86) PCT No.: PCT/GB2016/052268

§ 371 Date: Feb. 2, 2018

(30) Foreign Application Priority Data
Aug. 5, 2015 (GB) 1513855.5

(51) Int. Cl. H02G 1/12

(52) U.S. Cl. CPC H02G 1/1226; H02G 1/1297; H02G 1/1236

(57) ABSTRACT

This invention relates to a tool for stripping a surrounding layer from a sheathed cable. A tool for stripping a surrounding layer from an elongate electrical cable of substantially circular cross-sectional shape comprises a tool body having opposed jaws; a cable-receiving channel defined by formations in each of the jaws, the channel being configured to accommodate the end portion of a cable to be stripped with the formations fitting closely against the surrounding layer of the cable; and a cutting blade mounted in one of the jaws and having a cutting end positioned in the channel to penetrate the layer to a pre-set depth. The cutting end of the cutting blade has a cutting edge defined by facets of the blade disposed at an angle to the axis of the channel thereby to sever a helical strip of the surrounding layer from the end portion of a cable received in the channel on rotation of the tool around the cable. The jaws are resiliently separable and move away from each other from an initial position to allow the cable-receiving channel to accommodate therein the end portion of a cable of a diameter greater than the size of the channel when the jaws are in the initial position, to ensure the formations fit closely against the surrounding layer to ensure the pre-set depth of cut is delivered into the layer.

### BACKGROUND

### a. Field of the Invention

This invention relates to a tool for stripping a surrounding layer from a sheathed cable. In particular, though not exclusively, this invention relates to a tool for stripping a layer of insulation surrounding a conducting core of a round electrical cable, or for stripping an outer sheath surrounding such a layer of insulation, in either case from an end portion of the cable. Such tools are conventionally known as wire stripping tools.

### b. Related Art

Wire stripping tools are widely known and used throughout the electrical industries, for stripping insulation from a very wide variety of cable and wire types. Wire stripping tools have been developed to strip a fixed or chosen length of insulation or outer sheath from such cables and though some of these are more effective than others, they are known to suffer from certain disadvantages. Some of the tools have a large number of different parts which can lead to difficulties in the manufacture and assembly. In order not to damage the cable, the insulation or the conductors, the cutting edge of a blade must be accurately positioned and aligned relative to the cable to be stripped when received in the tool. The requirement to accurately position and align the blade leads to manufacturing complexity. Further, some tools may have exposed sharp blades and these can represent a significant health and safety risk, whereas other tools may be difficult or inconvenient to use.

The invention is primarily (but not solely) concerned with the stripping of a surrounding layer from an electrical cable having a single conducting core which itself may be of one or several conductors. The surrounding layer could comprise a single layer of insulation surrounding the conducting core, or could comprise a layer of insulation surrounding the core and an outer sheath surrounding the layer of insulation, for added protection against damage or for identification purposes. When stripping a cable having a single layer, removal of that layer exposes the conductors to allow the cable to be electrically connected to some other component. When stripping a cable having a layer of insulation and an outer sheath, quite often a greater length of outer sheath is removed than the length of insulation, giving rise to a so-called “two level strip”.

It is found that cables of a defined conductor core area (such as 16 mm² or 25 mm²) have significantly different insulation thicknesses and (if provided) outer sheaths. Variations are found as between different manufacturers and even for cables from the same manufacturer, due to manufacturing tolerances when moulding the insulating layer and the outer sheath therearound. If a cable of an expected size is to be stripped with a tool pre-set and configured for that cable size, it is found that it may not be possible to achieve an effective strip if the outer diameter of the cable is smaller than expected for a “typical” cable; and conversely if the cable is larger than expected, the removal of the outer sheath is likely to damage the insulating layer, and the removal of the insulation may damage the conductors.

It is a principal aim of the present invention to provide a tool for stripping a surrounding layer from a cable of a known conductor area; the tool being very simple and cost effective to manufacture and having few parts, but providing an accurate and precise stripping action for stripping either the outer sheath or the insulation from the cable, despite variations in the thicknesses of those surrounding layers.

### SUMMARY OF THE INVENTION

According to this invention, there is provided a tool for stripping a surrounding layer from an elongate electrical cable of substantially circular cross-sectional shape, comprising: a tool body having opposed jaws, said jaws being moveable relative to each other from an initial position; a cable-receiving channel defined by formations in each of the jaws, the channel being configured to accommodate the end portion of a cable to be stripped with the formations fitting closely against the surrounding layer of the cable; and a cutting blade mounted in one of the jaws and having a cutting end positioned in the channel to penetrate the surrounding layer to a pre-set depth. Such a tool is characterised in that the cutting end of the cutting blade has a cutting edge defined by facets of the blade disposed at an angle to the axis of the channel thereby to sever a helical strip of surrounding layer from the end portion of a cable received in the channel on rotation of the tool around the cable; and in that the jaws are resiliently separable and move away from each other from the initial position to allow the cable-receiving channel to accommodate therein the end portion of a cable of a diameter greater than the size of the channel when the jaws are in the initial position, to ensure the formations fit closely against the surrounding layer to ensure the pre-set depth of cut is delivered into the layer.

The channel will typically terminate in an opening in an end face of the tool body.

It will be appreciated that, though the tool is configured for stripping a cable having a single conducting core of a defined conductor area (such as 16 mm² or 25 mm²), the tool is able to perform effective stripping of a wide variety of such cables perhaps from different manufacturers or at different extremes of the manufacturing tolerances, by the jaws separating to the required extent to accommodate a chosen cable pushed into the opening of the tool. In this way, a clean and effective strip can be obtained, without damaging the conductors of the core or without damaging the insulation layer in the case of removal of the outer sheath from the insulation of a sheathed cable.

In its simplest form, the tool body and the opposed jaws may comprise a plastics material moulding with a slot between the jaws, whereby resilient deformation of the plastics material allows the jaws to move away from each other. Alternatively, the tool body may be formed in two parts each having one of the opposed jaws, the two parts being connected together by means allowing separation of the jaws to be resiliently increased. This may be achieved by providing a resilient band (such as a rubber or silicone rubber band) encircling the tool body, under tension. Though the band may encircle the opposed jaws, preferably the band encircles the tool body remote from the jaws. Another possibility is to use a spring clip, such as a C-shaped clip of spring metal to hold together the two parts of the tool while allowing the opposed jaws to separate resiliently.

In an alternative embodiment, a fastener may be provided to clamp together the two parts of the tool remote from the jaws, whereby resilient deformation of the plastics material allows the jaws to move away from each other. The plastics material may be given the required characteristics by appropriate selection of the material from which the parts are moulded, or perhaps by a co-moulding operation incorporating a more resilient plastics material into the tool body. A fulcrum may be provided between the two parts of the tool, the fastener being arranged to hold together the two parts of the tool remote from the jaws. In this case a spring may be disposed between the two parts to urge together the opposed jaws, or reliance may be placed on the resilient deformation of the plastics material as aforesaid.

An abutment such as an internal transverse wall may be provided within the tool body for engagement by the free end of a cable received in the opening, thereby to limit the length of surrounding layer which can be stripped from the cable end. An enlarged space may be provided within the tool adjacent the abutment, to allow room for the accommodation of a damaged cable end or conductors.

To allow the stripping of a cable having a single surrounding layer, or the outer sheath for a cable having two layers, the cable receiving opening may have a substantially constant cross-section. If the tool is to be used to strip a layer of insulation following the stripping of an outer sheath, the opening may have an outer part which fits closely to the sheath of the cable end and an inner part which fits closely to the exposed insulation of the cable end, and which serves to constrain movement of the cable end during the stripping action. Accordingly, in some embodiments the channel comprises a first section proximate the opening having a first radial dimension and a second section furthest from the opening having a second radial dimension, the second radial dimension being less than the first radial dimension.

Preferably, an aperture is formed through a side face of the tool to communicate with the cutting end of the cutting blade whereby a helical strip of the surrounding layer cut from a cable may leave the cable-receiving channel through the aperture.

A particularly preferred form of tool of this invention has first pair of opposed jaws and a second pair of opposed jaws, each pair having a cable receiving channel defined by formations in the jaws, the jaws being arranged such that the cable-receiving channels thereof are axially-aligned, and each channel having a cutting blade positioned therein. The configuration of the formations of the two pairs of jaws may be different to allow the performance of a two-level strip on a cable having an insulating layer surrounding the conducting core and a sheath surrounding the insulating layer.

In preferred embodiments the tool comprises a first channel formed by the first pair of opposed jaws that terminates in a first opening in a first end face of the tool body and a second channel formed by the second pair of opposed jaws that terminates in a second opening in a second end face of the tool body, the second end face being opposite to the first end face.

In some embodiments the first channel is substantially cylindrical and has a first radial dimension and the second channel is substantially cylindrical and comprises a first section having a radial dimension equal to the first radial dimension and a second section having a second radial dimension, the first radial dimension being greater than the second radial dimension. Preferably the second section of the second channel is further from the second opening than the first section of the second channel.

It will be appreciated that the tool of the present invention is preferably a hand tool.

### BRIEF DESCRIPTION OF THE DRAWINGS

By way of example only, one specific embodiment of an electrical cable stripping tool of this invention will now be described in detail, reference being made to the accompanying drawings in which:

FIG. 1 is an isometric view of the tool, with an electrical cable having a layer of insulation and an outer sheath about to be inserted into a first opening in the tool;

FIG. 2 shows the tool of FIG. 1 with the cable fully inserted therein and about to have outer sheath stripped therefrom;

FIG. 3 shows the tool being rotated to strip the outer sheath;

FIG. 4 shows the tool removed from the cable with a pre-determined length of outer sheath stripped from the cable;

FIG. 5 shows the cable fully inserted into a second opening in the tool and the tool being rotated to remove an inner layer of insulation from the conducting core of the cable;

FIG. 6 shows the tool removed from the cable with a two level strip completed on the cable; and

FIG. 7 is a partly cut away view of the tool showing a cable located therein at the completion of the removal of the inner insulation layer from the cable.

### DETAILED DESCRIPTION

Referring to the drawings, there is shown a hand tool 10 configured to perform a two-level strip on a cable 2 having an inner conducting core 3, a layer of insulation 4 around the core and an outer sheath 5 surrounding the insulation. The tool 10 comprises a body 11 having two body parts 12 and 13. The tool body 11 is preferably made from a moulded plastics material. The tool body 11 is elongate having opposite first and second end faces 14, 15. Each body part 12, 13 is also elongate and includes a part of each of the end faces 14, 15 of the tool. Each body part 12, 13 further includes a confronting face 16 (which may be substantially planar or curved), and the two parts 12, 13 are connected together such that the two confronting faces 16 oppose each other, Each body part 12, 13 further includes a side face 17 opposite to the confronting face 16. The side faces 17 and confronting faces 16 therefore extend along the length of the tool 10 between the first and second ends 14, 15.

Preferably the body parts 12, 13 are connected or clamped together in a central region 18 of the body 11. Typically the body parts 12, 13 are clamped together by means of a rivet 19. Aligned first and second pairs of opposed jaws 20, 21 project in opposite directions from the central region 18. In this way, each of the body parts 12, 13 includes a first jaw 20a, 20b extending from the central region 18 to the first end face 14 and a second jaw 21a, 21b extending from the central region 18 to the second end face 15. The regions of the confronting faces 16 corresponding to each pair of opposed jaws 20, 21 each have formations therein which define a cable receiving channel 22, 23. The cable receiving channel 22, 23 in each of the first and second pairs of jaws 20, 21 terminates in a generally circular opening 24, 25 in a respective one of the first and second end faces 14, 15. Each of the formations preferably comprises a semi-cylindrical surface. Each of the semi-cylindrical surfaces of a first pair of formations in the first pair of jaws 20 has a substantially uniform cross-sectional shape along an axial length of a first channel 22. In this way, each of the semi cylindrical surfaces in the first pair of jaws 20 has a first radius. A second channel 23 formed in the second pair of jaws 21 has an outer part or section 26, proximate the opening 25, of substantially the same cross-section as the first channel 22 and an inner part or section 27, further from the opening 25, of a smaller cross-section. In this way, each of the semi cylindrical surfaces in the second pair of jaws 21 includes a first section having a radius equal to the first radius, and a second section having a second radius that is smaller than the first radius. It is to be noted that the radial dimensions of each of the openings 24, 25 is substantially the same.

An axis of each of the channels 22, 23 extends from the opening 24, 25 in the respective end face 14, 15 towards the central region 18. The two channels 22, 23 in the tool body 11 are preferably axially aligned.

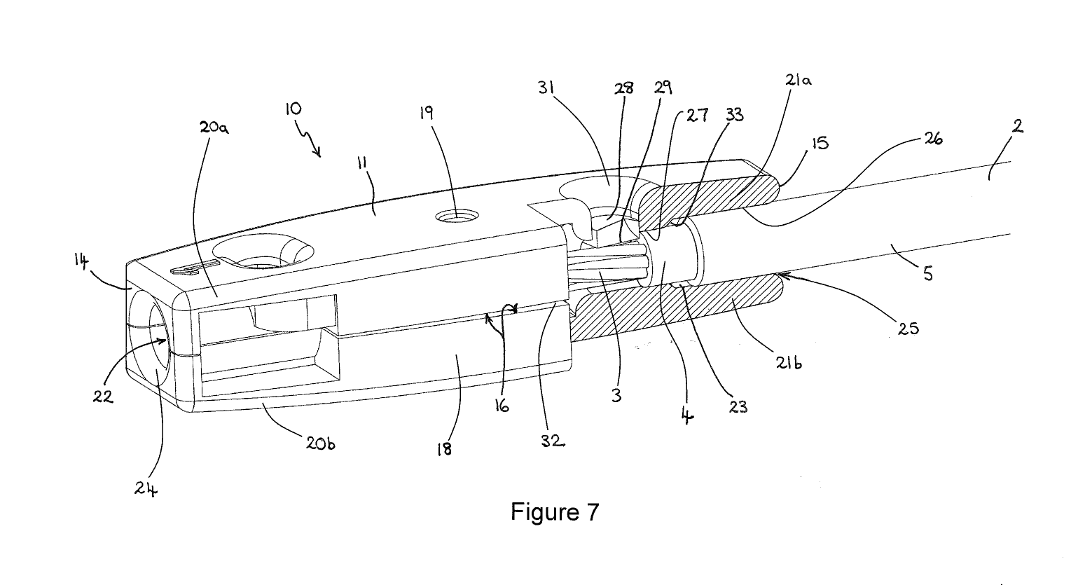

A respective cutting blade 28 (shown in FIG. 7) is mounted in one jaw 20a, 21a of each pair. The blade 28 is positioned to sever a layer (either the outer sheath 5 or the insulation 4, depending on the channel 22, 24) from a cable 2 inserted into the channel 22, 23, when the tool 10 is rotated about that cable 2 as will be described below.

Each cutting blade 28 has a cutting edge 29 defined by facets of the blade at the cutting end thereof. The cutting end projects into the respective channel 22, 23 with the cutting edge 29 accurately positioned within the respective jaw 20a, 21a, such that the cutting edge 29 cuts into the adjacent cable layer to an accurately pre-defined depth, defined by the formation of the jaw from which the blade projects.

The facets of the cutting end of the blade 28 lie at an angle to the axis of the respective channel 22, 23 so that on pushing the cable end into the opening 24, 25 and rotating the tool 10 around the cable 2, the blade 28 performs a helical cutting action, in effect threading itself along the cable 2 while partly cutting and partly shearing a strip 30 of the adjacent layer of the cable 2. The severed helical strip 30 exits the tool 10 through an aperture 31 formed in the jaw 20a, 21a of the tool 10 holding the cutting blade 28. The aperture 31 is preferably formed in the side face 17 of the body part 12, 13 and extends through the body part 12, 13 from the side face 17 to the channel 22, 23. Both the first pair of jaws 20 and the second pair of jaws 21 are similarly configured and each has an aperture 31 through which the severed helical strip 30 leaves the respective channel 22, 23 provided in those jaws 20, 21.

Each of the channels 22, 23 is preferably elongate with the openings 24, 25 being at a first end of the channel 22, 23. Though not shown in the drawings, an internal wall preferably extends transversely within the tool body 11 proximate or at a second end of each of the channels 22, 23. The internal wall therefore separates the first channel 22 from the second channel 23. To both sides of that wall, the tool body 11 may be formed to provide internal enlarged spaces. That is, an enlarged space may be formed between the second end of each channel 22, 23 and the internal wall. The enlarged space may have greater dimensions as compared to the sizes or radii of the channels 22, 23 within the jaws 20, 21. The enlarged spaces are provided to accommodate a damaged or splayed end of the cable 2. Each face of the internal wall provides an abutment surface. When a cable end is inserted into one of the channels 22, 23 in the tool 10, the end of the cable 2 will come into contact with a respective one of the abutment surfaces thereby preventing further insertion of the cable end into the channel 22, 23. The location of the internal wall relative to the position of the blade cutting edge 29 within the respective channel 22, 23 therefore defines the maximum length of the surrounding layer that is cut and stripped from the end of the cable 2.

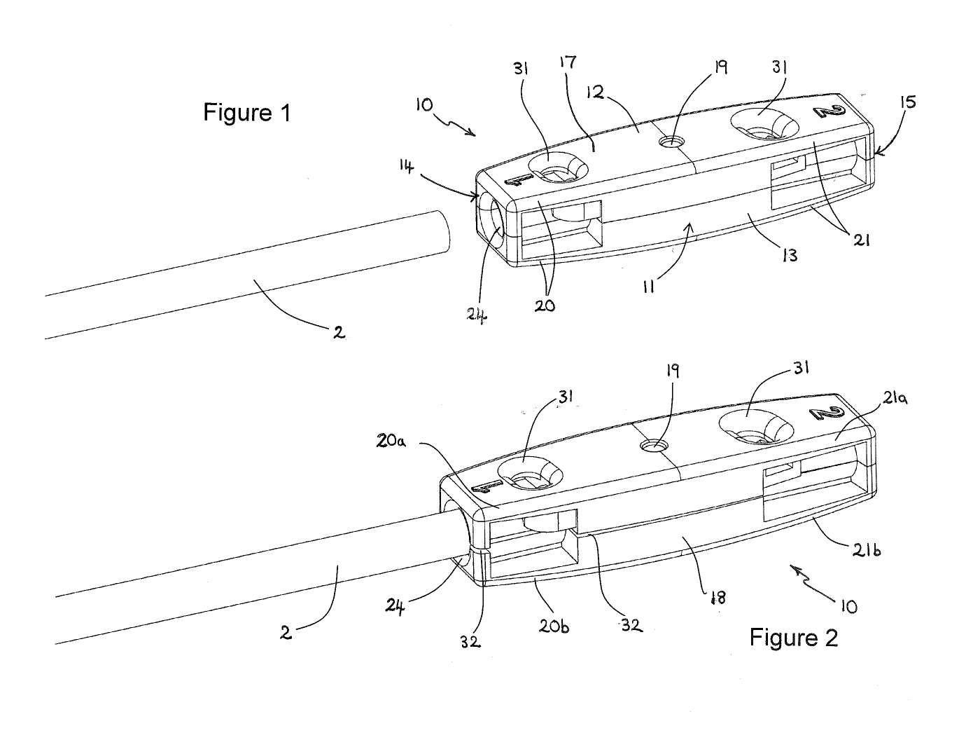

FIG. 1 shows an initial state of the tool 10, with the confronting faces 16 of each pair of opposed jaws 20 , 21 in contact with each other. Though not shown, it would be possible to have a small clearance gap between the jaws 20a, 20b, 21a, 21b of each pair when the jaws 20, 21 are in their initial position. On pushing a cable 2 to insert the cable end into the opening 24 defined by the first pair of jaws 20, the jaws 20a, 20b are pushed or sprung apart to a small extent by resilient deformation of the plastics material of the tool body 11, sufficient to allow the cable 2 to be inserted into the channel 22, with the formations defining the channel 22 fitting closely against the outer surface of the cable 2. This generates a small gap 32 between the jaws 20a, 20b, as shown in FIG. 2.

With the tool 10 in an initial state and the jaws 20 in a first configuration, there is, therefore, a first distance between the jaws 20a, 20b. This first distance may be zero. When a cable end is inserted into the channel 22, the jaws 20a, 20b are pushed apart by the cable end. This is possible because the two body parts 12, 13 are only connected in the central region 18. Each jaw 20a, 20b is, therefore, able to flex or bend about the connection. In preferred embodiments the resiliency of the material from which the body parts 12, 13 is made is such that there is a restoring force that acts on the jaws 20a, 20b urging them in a direction towards each other. As such, as the cable end pushes the jaws 20a, 20b apart, the restoring force causes the jaws 20a, 20b to clamp or grip the cable end. In other embodiments in which the jaws do not inherently provide a restoring force, a biasing means or member may be connected to the jaws. The biasing means or member applies a restoring force to the jaws to urge the jaws in a direction towards each other. The biasing means may comprise an elastic band or strap or a spring element.

Once a cable end has been inserted into the tool 10, with the jaws gripping a cable end, the jaws 20 are in a second configuration in which there is a second distance between the jaws 20a, 20b. This second distance is greater than or equal to the first distance. Preferably the second distance is greater than the first distance such that there is a positive gripping force applied to the cable end. It will be appreciated, however, that the first and second distances may be equal if the outer diameter of the cable end is equal to or slightly smaller than the diameter of the opening 24 and the respective channel 22.

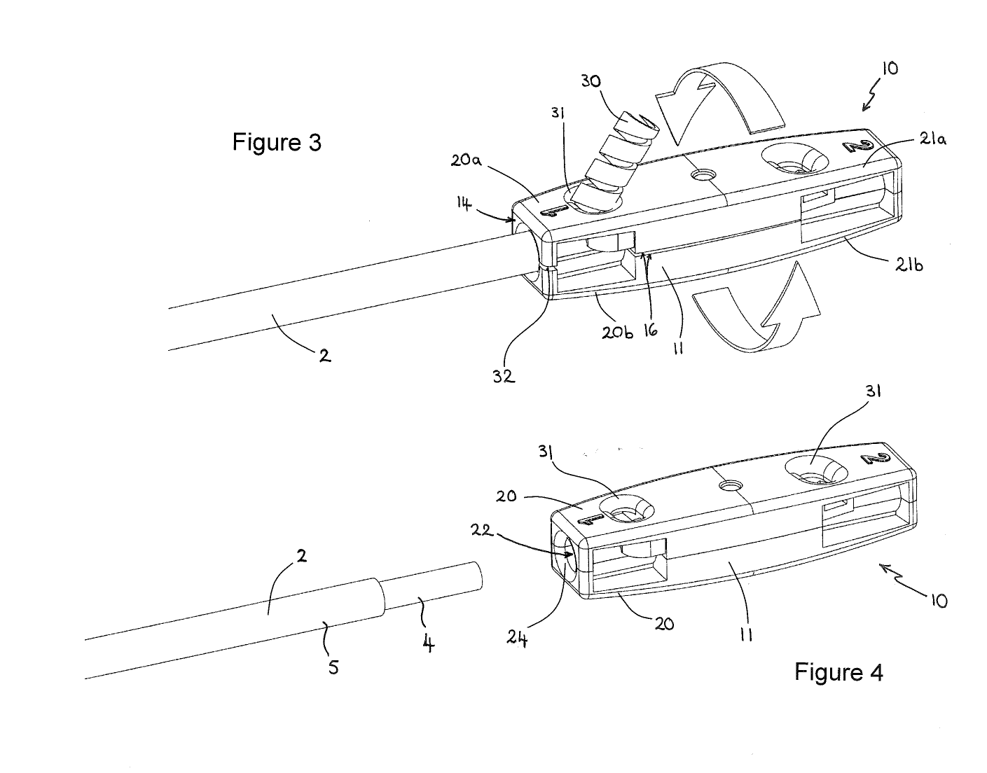

FIG. 3 shows the tool 10 being rotated about the cable 2 received in the opening 24, such that the facets of the cutting blade 28 partly cut and partly shear a helical strip 30 of outer sheath 5 from the end of the cable 2, the severed sheath leaving the tool through aperture 31. In view of the facets of the cutting blade 28 defining the cutting edge being disposed at an angle to the axis of the channel 22, the tool 10 threads itself along the cable 2 until the free end of the cable 2 abuts the internal transverse wall (not shown) provided within the tool 10. The tool 10 can then no longer thread itself along the cable and so continued rotation is in a radial plane with respect to the cable 2 and the cutting blade 28 makes a circumferential cut, completely severing the strip 30 of outer sheath 5 from the cable 2. FIG. 4 shows the cable 2 pulled out of the first opening 24 of the tool 10 with the first strip, of the outer sheath 5, fully completed.

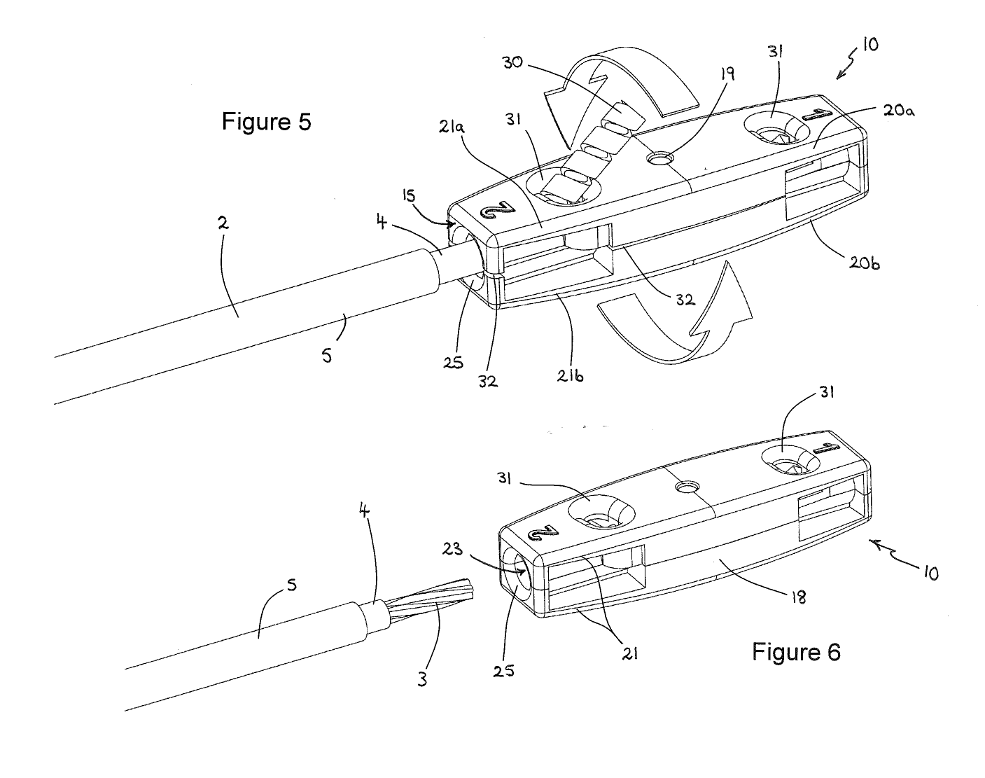

The end of the cable 2 is then inserted into the second opening 25 defined by the second pair of jaws 21 of the tool 10. In a similar manner to that described above, the confronting faces 16 (shown as curved) of the second pair of jaws 21 defining the second channel 23 are initially in contact (though perhaps with a small clearance therebetween, as mentioned above) but on pushing the cable end into the channel 23, the jaws 21a, 21b are sprung apart to a small extent by resilient deformation of the plastics material of the jaws 21. This generates a small gap between the jaws 21a, 21b, as shown in FIG. 5, with the formations fitting closely against the outer surfaces of the cable end. The outer section 26 of the channel 23 fits closely against the outer sheath 5 of the cable 2 and the inner section 27 fits closely against the layer of insulation 4 around the core of conductors 3 of the cable 2, exposed in the first strip. As with the first strip, the tool 10 is rotated about the cable 2 so as to cut a helical strip 30 of insulation from the cable 2, that strip exiting the tool 10 through the corresponding aperture 31 adjacent the cutting blade 28 of the second pair of jaws 21. Rotation is continued until the free end of the conducting core 3 abuts the transverse wall within the tool 10; the tool 10 can then no longer thread itself along the cable 2 so that continued rotation of the tool 10 performs a circumferential cut in a radial plane thereby completely severing the strip 30 from the cable end. FIG. 6 shows the cable 2 pulled out of the second opening 25 of the tool 10 with the two level strip fully completed, exposing a pre-determined length of conductors 5 and a predetermined length of insulation 4.

FIG. 7 shows a partly cut-away view of the tool 10 in the region of the second channel 23, together with a cable 2 inserted into the channel 23. The cable 2 is shown at the completion of the second strip to remove the pre-determined length of insulation 4 from the conductors 3. As can be seen, the formations in the confronting faces 16 of the second pair of opposed jaws 21 define essentially cylindrical outer and inner sections or bores 26 and 27, there being a step or shoulder 33 between the outer and inner bores 26, 27. The diameter of the outer bore 26 is essentially equal to the anticipated diameter of the outer sheath 5 of a cable 2 with which the tool 10 is to be used, when at the smallest end of the manufacturing tolerances for such cables. Similarly, the diameter of the inner bore 28 is no smaller than the anticipated diameter of the inner insulation of a cable with which the tool is to be used, when at the smallest end of the manufacturing tolerances for such cables. In practice, most cables will be slightly larger than the smallest anticipated diameter and some cables might be at the largest end of the manufacturing tolerances for such cables. Further, cables from different manufacturers may have slightly different sizes for the layers of insulation and outer sheath, for the same conductor core sizes. Whichever cable 2 is to be stripped, on pushing the cable end into the required channel 22, 23 the respective jaws 20, 21 are pushed or sprung apart slightly to allow accommodation of that cable end with the formations defining the channel 22, 23 fitting closely to the cable end, as shown in FIGS. 5 and 7, so ensuring an effective strip. It should be noted that the inner bore 27 serves to support the cable end being stripped to ensure the cutting action does not damage the conductors 3 while effectively removing the insulation layer 4.

What is claimed is:

1. A tool for stripping a surrounding layer from an elongate electrical cable of substantially circular cross-sectional shape, comprising:
a tool body having opposed jaws, said jaws being moveable relative to each other from an initial position;
a cable-receiving channel defined by formations in each of the jaws, the channel being configured to accommodate the end portion of a cable to be stripped with the formations fitting closely against the surrounding layer of the cable; and
a cutting blade mounted in one of the jaws and having a cutting end positioned in the channel to penetrate the layer to a pre-set depth;
characterised in that the cutting end of the cutting blade has a cutting edge defined by facets of the blade disposed at an angle to the axis of the channel thereby to sever a helical strip of the surrounding layer from the end portion of a cable received in the channel on rotation of the tool around the cable;
and in that the jaws are resiliently separable and move away from each other from the initial position to allow the cable-receiving channel to accommodate therein the end portion of a cable of a diameter greater than the size of the channel when the jaws are in the initial position, to ensure the formations fit closely against the surrounding layer to ensure the pre-set depth of cut is delivered into the layer.

2. A tool as claimed in claim 1, wherein the channel terminates in an opening in an end face of the tool body.

3. A tool as claimed in claim 1, wherein the tool body and the opposed jaws comprises a plastics material moulding with a slot between the jaws, whereby resilient deformation of the plastics material allows the jaws to move away from each other.

4. A tool as claimed in claim 1, wherein the tool body is formed in two parts each having one of the opposed jaws, the two parts being connected together by means allowing separation of the jaws to be resiliently increased.

5. A tool as claimed in claim 4, wherein a resilient band encircles the tool body, under tension.

6. A tool as claimed in claim 5, wherein the resilient band encircles the tool body remote from the jaws.

7. A tool as claimed in claim 4, wherein a spring clip at least partially surrounds the tool to hold together the two parts of the tool remote from the jaws, the spring clip allowing resilient separation of the opposed jaws.

8. A tool as claimed in claim 4, wherein a fastener is provided to clamp together the two parts of the tool remote from the jaws, whereby resilient deformation of the plastics material allows the jaws to move away from each other.

9. A tool as claimed in claim 4, wherein a fulcrum is provided between the two parts, a fastener being arranged to hold together the two parts of the tool remote from the jaws, and a spring is disposed between the two parts to urge together the two jaws.

10. A tool as claimed in claim 9, wherein the spring comprises a helical compression spring disposed on the side of the fulcrum opposed to the jaws.

11. A tool as claimed in claim 1, wherein an abutment is provided within the tool body for engagement by the free end of a cable received in the channel, thereby to limit the length of surrounding layer stripped from the cable.

12. A tool as claimed in claim 1, wherein the cable receiving channel has an outer part which fits closely to the sheath of a cable being stripped and an inner part deeper in the channel and which fits closely to the insulating layer of a cable being stripped.

13. A tool as claimed in claim 2, wherein the channel comprises a first section proximate the opening having a first radial dimension and a second section furthest from the opening having a second radial dimension, the second radial dimension being less than the first radial dimension.

14. A tool as claimed in claim 1, wherein an aperture is formed through a side face of the tool to communicate with the cutting end of the cutting blade whereby a severed surrounding layer cut from a cable may leave the cable-receiving channel through the aperture.

15. A tool as claimed in claim 1, wherein the tool body has first pair of opposed jaws and a second pair of opposed jaws, each pair of jaws having a respective cable receiving channel defined by formations in the jaws, the jaws being arranged such that the cable-receiving channels thereof are axially-aligned, and each channel having a respective cutting blade positioned therein.

16. A tool as claimed in claim 15, wherein a first channel formed by the first pair of opposed jaws terminates in a first opening in a first end face of the tool body and a second channel formed by the second pair of opposed jaws terminates in a second opening in a second end face of the tool body, the second end face being opposite to the first end face.

17. A tool as claimed in claim 15, wherein the formations defining the channels of the two sets of jaws are of different configurations, whereby a cable having two layers surrounding inner conductors may be stripped to expose the conductors and the inner layer, by selection of the opening.

18. A tool as claimed in claim 15, wherein the first channel is substantially cylindrical and has a first radial dimension and the second channel is substantially cylindrical and comprises a first section having a radial dimension equal to the first radial dimension and a second section having a second radial dimension, the first radial dimension being greater than the second radial dimension.

19. A tool as claimed in claim 18, wherein a first channel formed by the first pair of opposed jaws terminates in a first opening in a first end face of the tool body and a second channel formed by the second pair of opposed jaws terminates in a second opening in a second end face of the tool body, the second end face being opposite to the first end face and wherein the second section of the second channel is further from the second opening than the first section of the second channel.

20. A tool as claimed in claim 1, wherein the tool is a hand tool.

21. (canceled)
